(19) United States
(12) Patent Application Publication
(10) Pub. No.: US 2019/0030381 A1
(43) Pub. Date: Jan. 31, 2019

(54) FALL PROTECTION DEVICE WITH BUFFERING CAPABILITY

(71) Applicant: YOKE INDUSTRIAL CORP., TAICHUNG CITY (TW)

(72) Inventor: WEI-CHIEH HUNG, TAICHUNG CITY (TW)

(73) Assignee: YOKE INDUSTRIAL CORP., TAICHUNG CITY (TW)

(21) Appl. No.: 15/662,181

(22) Filed: Jul. 27, 2017

(51) Int. Cl. A62B 35/04; A62B 35/00

(52) U.S. Cl. CPC A62B 35/04; A62B 35/0037

(57) ABSTRACT

A fall protection device with buffering capability, adapted to be connected to a safety belt, includes a frame body, a rotation unit disposed in the frame body, and a buffer device; wherein the rotation unit is adapted to roll up the safety belt. The buffer device includes a buffer rod and a buffer unit; wherein the buffer rod is adapted to be connected to an anchoring point, and includes a first friction surface; the buffer unit is disposed in the frame body and includes a second friction surface cooperated with the first friction surface. Between the buffer rod and the buffer unit, when the safety belt bears a pulling force greater than a default value, the safety belt pulls the frame body and to make the buffer unit connected with the frame body overcome a maximum static friction, and slide with friction on the buffer rod.

### BACKGROUND OF THE INVENTION

### 1. Technical Field

The present invention is related to a fall protection device, and more particularly to a fall protection device with buffering capability.

### 2. Description of Related Art

Working in elevated environments like roofs, factories, construction sites, aerospace bases, or in the situations like elevator repairing or shipbuilding, workers are usually required to wear safety equipment like fall protection device when they are working. The fall protection device is adapted to be connected with a safety belt, and the safety belt is fastened to the worker. When the worker falls from an elevated site accidentally, the fall protection device can stop or buffer the safety belt to prevent the worker continue to fall or slow down the falling speed of the worker to secure the safety of the worker.

Conventional fall protection devices may include an elastic stretch design for the safety belt, with this design as the worker attached with the safety belt falls, this stretchable safety belt can buffer or slow down the falling speed of the worker. However, the length, the elastic modulus, the height of the work site, also the weight of the worker, all of them must be considered when design the safety belt. In the case that the length of the safety belt is too long, once the worker falls without the rebounding of the safety belt and hits the ground, injuries may occur.

There is another overlay-sewing design for a portion of the safety belt, with this design as the worker attached with the safety belt falls, the overlay-sewing portion of the safety belt will be ripped by the downward force, absorb the downward impulsive force of the worker, and provide the buffer effect. However, this design may damage the structure of the safety belt, affect its strength, and lower the load-bearing capacity.

Besides, there is also a design for rapid lock-up. As the worker falls, the pulling force will make the fall protection device lock up the safety belt, immediately, and prevent the worker continue to drop. However, this design may cause an instant impact force (like G-Force) and a reaction force which may cause organ injuries or bone fractures.

### BRIEF SUMMARY OF THE INVENTION

In view of the above, a purpose of the present invention is to provide a fall protection device with buffering capability to buffer the falling speed of a user.

The present invention provides a fall protection device with buffering capability. The fall protection device is adapted to be connected to a safety belt and includes a frame body, a rotation unit, and a buffer device; wherein the rotation unit is disposed in the frame body and adapted to roll up the safety belt. The buffer device includes a buffer rod and a buffer unit; wherein the buffer rod is adapted to be connected to an anchoring point, and includes a first friction surface. The buffer unit is disposed in the frame body and includes a second friction surface cooperated with the first friction surface. Between the buffer rod and the buffer unit, when the safety belt bears a pulling force greater than a default value, the safety belt pulls the frame body to make the buffer unit connected to the frame body overcome a maximum static friction and slide with friction on the buffer rod.

The advantage of the present invention is that when the worker attached with the safety belt falls, one end of the safety belt bears a pulling force greater than a default value; the safety belt pulls the frame body to make the buffer unit connected with the frame body overcome the maximum static friction, and slide with friction on the buffer rod. The sliding friction produced between the buffer rod and the buffer ring is able to buffer and absorb the downward impulsive force of the worker, slow down the falling speed of the worker and decrease the injury to the worker; also, decrease the opportunity for secondary damage due to the rebounding of the safety belt.

### BRIEF DESCRIPTION OF THE SEVERAL VIEWS OF THE DRAWINGS

FIG. 1 is a perspective view of a fall protection device with buffering capability of an embodiment according to the present invention;

FIG. 2 is an exploded view of the fall protection device with buffering capability of the above embodiment;

FIG. 3 and FIG. 4 are the sectional views of the fall protection device of FIG. 1 as viewed along line A-A of FIG. 1, showing the before-and-after status of the sliding with friction caused between the buffer ring and the buffer rod; and

FIG. 5 is a cross-sectional view of the fall protection device with buffering capability of another embodiment according to the present invention.

### DETAILED DESCRIPTION OF THE INVENTION

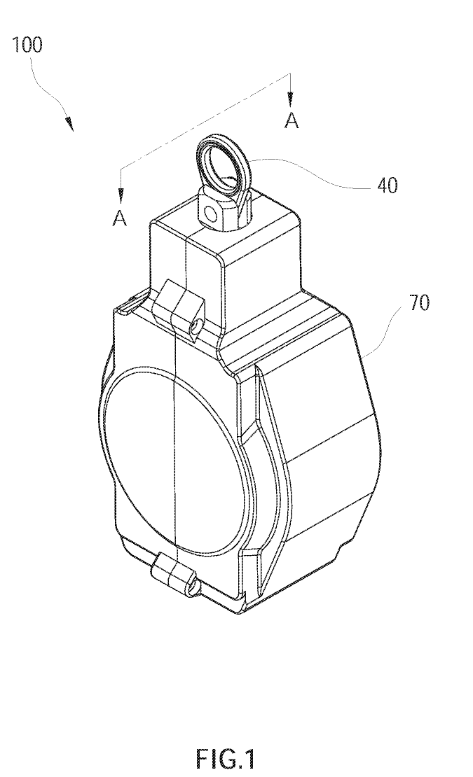

Referring to FIG. 1 to FIG. 3, an embodiment of the present invention provides a fall protection device 100 with buffering capability. The fall protection device 100 includes a frame body 10, a rotation unit 20, and a buffer device 30.

The frame body 10 includes a top plate 12 and two lateral plates 14. The top plate 12 is disposed between the two lateral plates 14, and the two lateral plates are connected with the top plate 12. The top plate 12 and the two lateral plates 14 constitute a containing space for containing the rotation unit 20. One of the lateral plates 14 includes a through hole 14a, and the other one includes a through hole 14b; the through hole 14a and the through hole 14b are co-axial.

The rotation unit 20 includes a shaft 22 and a rotary drum 24. The shaft 22 penetrates through the through hole 14a. The rotary drum 24 is mounted on the shaft 22 and rotated with the shaft 22 co-axially. The rotary drum 24 is adapted to roll up the safety belt 26. One end of the safety belt is connected to a worker or a hanging point of a safety equipment wearing by the worker. In one embodiment, the rotary drum 24 and the shaft 22 are fitted with each other closely; the fitting method, for example, could be the Clearance Fit, the Transition Fit, or the Interference Fit, optionally. With this close-fitting design of the rotary drum 24 and the shaft 22, when the rotation of the shaft 22 is stopped, the rolling friction caused between the rotary drum 24 and the shaft 22 can slow down the falling speed resulted from the pulling from safety belt 26 and the falling speed of the worker attached with this safety belt 26. In other applications, however, the fitting method of the shaft 22 and the rotary drum 24 is not limited to the methods mentioned above.

The buffer device 30 includes a buffer unit 80 and a buffer rod 34, in this embodiment, the buffer unit 80 includes a frame 32 and a buffer ring 36. The frame 32 is assembled to the frame body 10. In this embodiment, for example, multiple locating holes at the bottom of frame 32 are provided to be penetrated by fixing units, like bolts, to fasten the frame 32 to the frame body 10. However, other fixation methods are also suitable for other applications, those methods are not limited to the method mentioned above.

The buffer rod 34 can be disposed on the frame body 10. In this embodiment, the buffer rod 34 is disposed between the frame body 10 and the frame 32. The buffer rod 34 is disposed in the frame 32, one end of the buffer rod 34 penetrates through a through hole 32a of the frame 32 and connects to an anchoring point. In this embodiment, one end of the buffer rod 34 is adapted to be connected to a hanging ring 40 provided to be hanged or to be secured at an anchoring point or an anchor point. Also, the buffer rod 34 can be adapted with a hanging strap to connect to the anchoring point or the anchor point. In which, the said anchoring point includes, for example, a steel reinforcing bar or a pillar which are capable of providing a connection point for the buffer rod 34, but it is not limited thereto. In addition, the buffer rod 34 includes a first friction surface 34a, in this embodiment, the said first friction surface 34a is constituted by an exterior surface of buffer rod 34. Meanwhile, the butter rod 34 includes a flange 35 at its bottom section. The flange 35 is protruded from an exterior surface of the buffer rod 34.

The buffer ring 36 of the buffer unit 80 includes a second friction surface 36a, and the second friction surface 36a cooperates with the first friction surface 34a. In this embodiment, the said buffer ring 36 includes a through hole 32a. Through the through hole 32a of the frame 32, the buffer ring 36 is mounted on the buffer rod 34. An interior surface of through hole 32a constitutes a second friction surface 36a, in which, the second friction surface 36a of the buffer ring 36 and the first friction surface 34a of the buffer rod 34 are fitted with each other closely. The fitting method could be, for example, the Clearance Fit, the Transition Fit, or the Interference Fit.

Furthermore, in this embodiment, the buffer device 30 includes a spring 38. The spring 38 is connected to the buffer rod 34, and adapted to provide the buffer rod 34 an elastic force. Wherein, in this embodiment, the spring 38 is a compression spring and is mounted on the buffer rod 34. The spring 38 includes two ends, wherein one end of the spring 38 abuts against the flange 35 of the buffer rod 34, and the other end abuts against the buffer unit 36.

In addition, in this embodiment, the fall protection device 100 further includes a brake unit 50, a rewinding unit 60, and a housing 70.

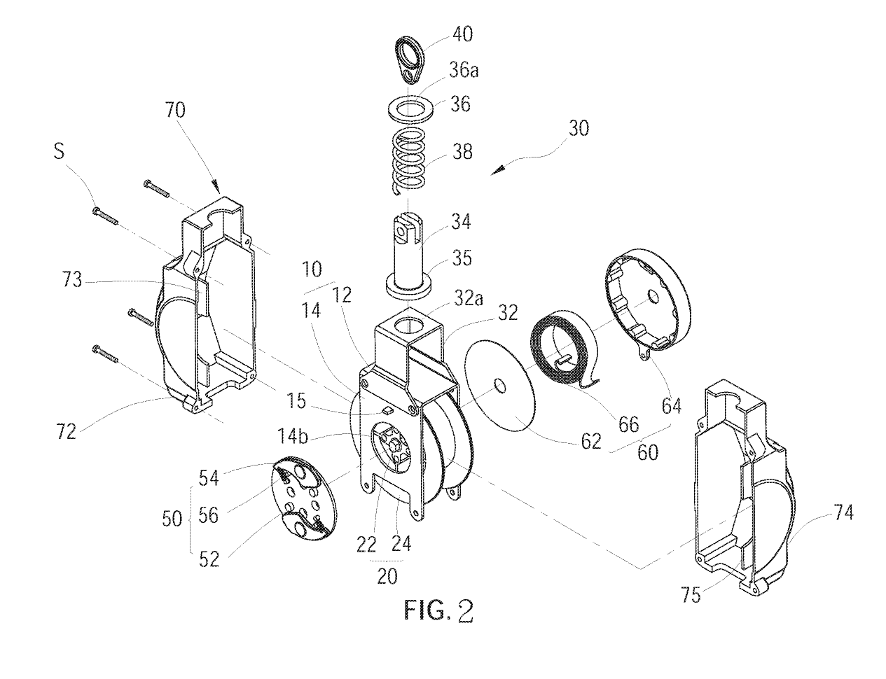

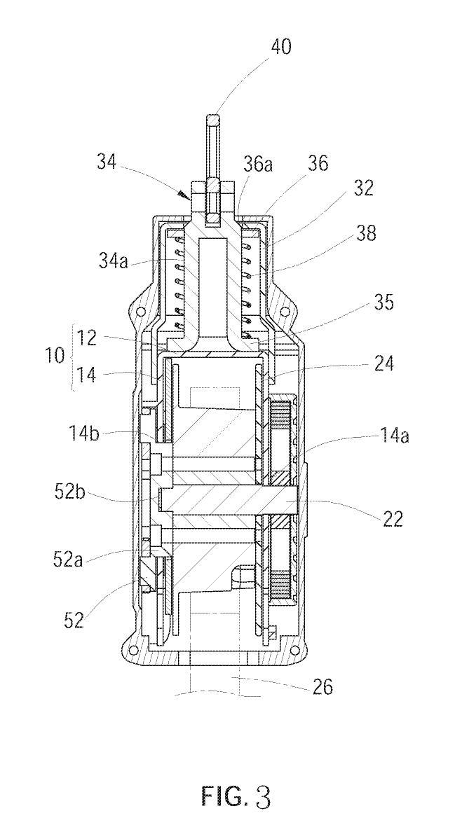

The brake unit 50 is mounted on the rotation unit 20. In this embodiment, referring to FIG. 2 and FIG. 3, the brake unit 50 includes a braking plate 52, two braking parts 54, and two restoring springs 56. The braking plate 52 includes a protrusion part 52a. The protrusion part 52a penetrates through the through hole 14b of the lateral plate 14. The protrusion part 52a includes a recess 52b adapted to be engaged with the shaft 22 so as to fix the shaft 22. Whereby the braking plate 52 is rotated with the shaft 22 co-axially. The two braking parts 54 pivotally connect to the braking plate 52, respectively. Each of the two restoring springs 56 connects to the braking part 54 with one end, and connects to the braking plate 52 with the other end so as to respectively provides an elastic force to each of the two braking parts 54 and provides each of the two braking parts 54 a positioning with a normal tendency to move inward, respectively.

The rewinding unit 60 further includes a first cover 62, a second cover 64, and a spiral spring 66. The first cover 62 connects to the second cover 64. The first cover 62 and the second cover 64 constitute a containing space for containing the spiral spring 66. The spiral spring 66 connects to the shaft 22 with one end and connects to the second cover 64 with the other end and provides a normal tendency for the spiral spring 66 to coil up.

The housing 70 is adapted to contain the frame body 10, the rotation unit 20, the buffer device 30, the brake unit 50, and the rewinding unit 60. Particularly, the housing 70 includes a first half housing 72 and a second half housing 74; the first half housing 72 and the second half housing 74 are joined to each other. The first half housing 72 includes a first division plate 73 disposed therein, and the second half housing 74 also includes a second division plate 75 disposed therein opposite to the first division plate 73. The first half housing 72 connects the second half housing 74 with fixing units, like bolts. When the first half housing 72 and the second half housing 74 are combined together, the first division plate 73 is joined with the second division plate 75. Meanwhile, the containing space inside the housing 70 is divided into two portions by the connection of two plates. The frame body 10 and the rotation unit 20 are disposed at one side inside of the housing 70 corresponding to the first division plate 73 and the second division plate 75; and the brake unit 50 is disposed at another side inside of the housing 70 corresponding to the first division plate 73 and the second division plate 75. With the design of the first division plate 73 and the second division plate 75, the rotation unit 20 are isolated from the brake unit 50 so as to prevent the brake unit 50 from being entered or adhered by small objects like dust particles caused by the safety belt 26 when it's being wound by the rotation unit 20, and decrease the opportunity for affecting the operation of the brake unit 50. Meanwhile, containing the spiral spring 66 inside the first cover 62 and the second cover 64 brings the capability to prevent from being entered by small objects like dust particles. In addition, the isolation brought from the top plate 12 also provides the buffer device 30 the capability to prevent from being entered or adhered by small objects like dust particles caused by the rotation unit 20 and the safety belt 26. The position of the buffer device 30 is not limited to the said location, in one embodiment, the buffer device 30 is exposed outside the housing 70 instead of being contained inside the housing 70.

With the above mentioned design, in normal situation, for example, as a worker walks normally on a working platform or a pallet, the rotation unit 20, the brake unit 50, and the rewinding unit 60 rotates co-axially (synchronous rotary). When the safety belt 26 bears a pulling force smaller than a default value, for example, the worker attached with the safety belt 26 is away from the fall protection device 100 and the safety belt 26 is being pulled, the spiral spring 66 of the rewinding unit 60 stretches and stores a restoring force (elastic force) for coiling because of the pulling from the safety belt 26. On the contrary, when the worker approaches to the fall protection device 100, the force to pull the safety belt 26 will decrease to a value lower than the elastic force of spiral spring 66 such that the elastic recovery appears and the spiral spring 66 coils back so as to drive the safety belt 26 to coil up around the rotary drum 24, again.

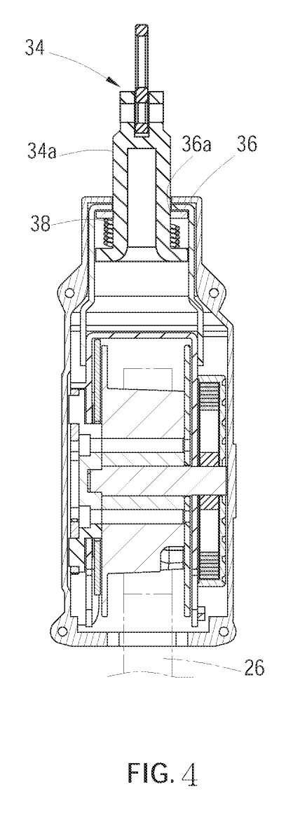

In another situation that the safety belt 26 is being pulled rapidly at a moment, for example, a worker attached with the safety belt 26 falls from an elevated site accidentally, the safety belt 26 is pulled out rapidly and bears a pulling force greater than the default value. The braking parts 54 of the brake unit 50 are driven to overcome the elastic force of the restoring spring 56, and are spun out. Hence, the braking parts 54 will engage with the stopper 15 which is disposed in the frame body 10; and the braking plate 52, also the shaft 22 which is securely connected with the braking plate 52, will be secured because of the engagement between braking part 54 and stopper 15. Referring to FIG. 2 and FIG. 3, because of the engagement of the brake unit 50 and the secure fixation of the shaft 22, the pulling force on safety belt 26 pulls down the frame body 10 also the frame 32 connected with the frame body 10. Simultaneously, the frame 32 brings the buffer ring 36 to move downward, and the second friction surface 36a of the buffer ring 36 is driven to overcome the maximum static friction between the first friction surface 34a and thereof. The buffer ring 36 slides with friction on the buffer rod 34, and the two displace relatively as the shown in FIG. 4. Wherein, this sliding friction produced between the first friction surface 34a of the buffer rod 34 and the second friction surface 36a of the buffer ring 36 buffers the downward force (impulsive force) of both the safety belt 26 and the worker attached with the safety belt 26. The purposes of buffering and absorbing the downward impulsive force of the worker, slowing down the falling speed of the worker, and decreasing injury to the worker; also, decreases opportunity of secondary damage due to the rebounding of safety belt 26 are achieved.

Referring to FIG. 3 and FIG. 4, in this embodiment a spring 38 can be disposed between the buffer rod 34 and the buffer ring 36. The spring 38 is disposed between the buffer rod 34 and the buffer ring 36, and an elastic force of the spring 38 abuts against the buffer rod 34 and the buffer ring 36. The elastic force and the sliding friction between the buffer rod 34 and the buffer ring 36 bring a further improvement of buffering and offsetting the downward impulsive force of both the safety belt 26 and the worker. For example, when the safety belt 26 is pulled down, the safety belt 26 pulls both the rotation unit 20 and the frame body 10, a relative displacement (sliding) appears between the buffer ring 36 and the buffer rod 34 so as to compresse the spring 38 disposed between the buffer ring 36 and the buffer rod 34. The reverse force produced by the compression is adapted to buffer the downward impulsive force of the safety belt 26. In addition, in a situation that the downward impulsive force is offset, the restoring force of the spring 38 is adapted to restore the buffer rod 34 and the buffer ring 36 back to initial status as shown in FIG. 3. In other applications, the spring 38 can not be included. In an embodiment that the spring 38 is not included, the downward impulsive force of the safety belt 26 is only buffered with the sliding friction caused by the sliding with friction caused between the buffer rod 34 and the buffer ring 36.

Moreover, in an embodiment, the spring can be a tension spring. The tension spring connected between the frame body 10 and the buffer rod 34 provides an elastic force that stores the buffer rod 34 back to its normal position. Hence, the spring is not limited to the said compression spring. Besides, other kinds of spring are also suitable for other applications, those springs are not limited to that as mentioned above.

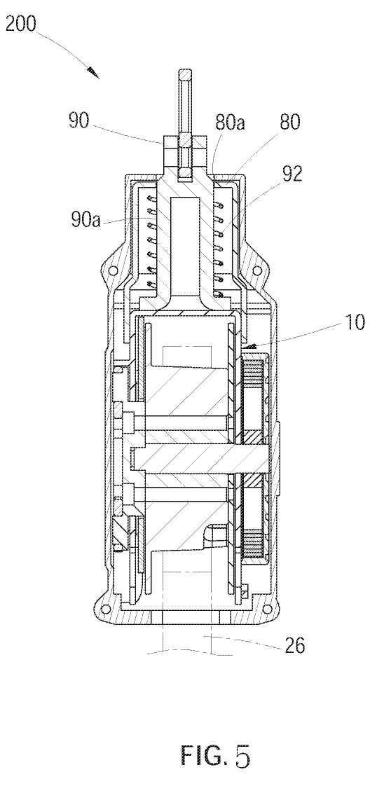

Referring to FIG. 5, another embodiment of the present invention provided a fall protection device 200. The fall protection device 200 is different from the fall protection device 100 in that: The buffer device of the fall protection device 200 includes a buffer unit 80 and a buffer rod 90. The buffer unit 80 is disposed in the frame body 10 and includes a through hole; an inside wall of the through hole constitutes the second friction surface 80a. The buffer rod 90 is disposed between the frame body 10 and the buffer unit 80; one end of the buffer rod 90 penetrates through the through hole; and an exterior surface of the buffer rod 90 constitutes a first friction surface 90a cooperated with the second friction surface 80a. Whereby, with sliding with friction between the buffer unit 80 and the buffer rod 90, the purposes of buffering the downward impulsive force and slowing down the falling speed of both the safety belts and the worker are still able to be achieved. In addition, the buffer device includes a spring 92 connected with the buffer rod 90, and the spring 92 is adapted to provide the buffer rod 90 a suitable elastic force. For example, in this embodiment, the spring 92 is a compression spring and is mounted on the buffer rod 90. The spring 92 abuts against the buffer rod 90 with one end, and abuts against the buffer unit 80 with another end such that a good buffer effect is provided.

It should be noted that in the statement “the safety belt bears a pulling force greater or smaller than a default value” as mentioned above, the said default value is served only as a reference to determine whether the buffer function of a buffer device should be activated. Different applications in practice, the said default value may be different due to different configurations of a fall protection device. For example, the said default value is primarily the friction between the buffer rod and the buffer unit, however, in the situation that a spring is included in a buffer device, the elastic force provided by the spring should be also considered. In addition, in an embodiment that the brake unit or the rewinding unit can not be included. For example, when the safety belt 26 wound around the rotation unit is pulled out from rotation unit till stop, like being pulled or almost being pulled to the end-position, the action force applied to the rotation unit by the safety belt is greater than the default value and pulls the buffer unit of the buffer device. The sliding with friction caused between the buffer unit and the buffer rod is adapted to buffer the downward impulsive force.

It must be pointed out that the embodiments described above are only some embodiments of the present invention. Fall protection capability provided by the fall protection device of the present invention is not only adapted to buffer the falling force of the workers but also the construction materials or equipment. All equivalent structures which employ the concepts disclosed in this specification and the appended claims should fall within the scope of the present invention.

What is claimed is:

1. A fall protection device with buffering capability, adapted to be connected to a safety belt, comprising:
a frame body;
a rotation unit disposed in the frame body, wherein the rotation unit is adapted to roll up the safety belt; and
a buffer device, comprising a buffer rod and a buffer unit;
wherein the buffer rod is adapted to be connected to an anchoring point, and includes a first friction surface; the buffer unit is disposed in the frame body, and includes a second friction surface cooperated with the first friction surface; and between the buffer rod and the buffer unit, when the safety belt bears a pulling force greater than a default value, the safety belt pulls the frame body to make the buffer unit connected to the frame body overcome a maximum static friction, and slide with friction on the buffer rod.

2. The fall protection device with buffering capability of claim 1, wherein the buffer device further comprises a spring, connected with the buffer rod, and adapted to provide the buffer rod an elastic force.

3. The fall protection device with buffering capability of claim 2, wherein the spring includes two ends; one end of the spring abuts to the buffer rod, and the other end of the spring abuts against the buffer unit.

4. The fall protection device with buffering capability of claim 1, wherein the buffer unit comprises a frame and a buffer ring; the frame is disposed on the frame body and includes a through hole; the buffer rod is disposed in the frame and one end of the buffer rod penetrates through the through hole of the frame; the buffer ring is disposed between the frame and the frame body, and includes the second friction surface.

5. The fall protection device with buffering capability of claim 4, wherein the buffer device comprises a spring; wherein the spring is mounted on the buffer rod; one end of the spring abuts against a flange of the buffer rod, and the other end of the spring abuts against the buffer unit.

6. The fall protection device with buffering capability of claim 1, wherein an exterior surface of the buffer rod constitutes the first friction surface; the buffer unit includes a through hole, and an interior surface of the through hole constitutes the second friction surface.

7. The fall protection device with buffering capability of claim 1, further comprising a brake unit and a housing; wherein the brake unit is mounted on the rotation unit and adapted to limit a rotation of the rotation unit; the housing includes a first half housing and a second half housing which are joined to each other; the first half housing includes a first division plate disposed therein, and the second half housing includes a second division plate disposed therein which is opposite to the first division plate; the rotation unit is disposed at one side inside of the housing corresponding to the first division plate and the second division plate; the brake unit is disposed at another side inside of the housing corresponding to the first division plate and the second division plate.

8. The fall protection device with buffering capability of claim 7, wherein the buffer unit is disposed in the frame body, and the buffer unit includes a through hole; an interior surface of the through hole constitutes the second friction surface; an exterior surface of the buffer rod constitutes the first friction surface.

9. The fall protection device with buffering capability of claim 7, wherein the rotation unit comprises a shaft and a rotary drum; the brake unit is secured to the shaft; the rotary drum is mounted on the shaft and is rotated co-axially with the shaft.

10. The fall protection device with buffering capability of claim 9, wherein the rotary drum and the shaft are fitted with each other closely.
